(19) United States
(12) Patent Application Publication
(10) Pub. No.: US 2020/0105302 A1
(43) Pub. Date: Apr. 2, 2020

(54) EDITING APPARATUS FOR CONTROLLING REPRESENTATIVE IMAGE TO APPROPRIATE IMAGE, METHOD OF CONTROLLING THE SAME, AND STORAGE MEDIUM THEREFOR

(71) Applicant: CANON KABUSHIKI KAISHA, Tokyo (JP)

(72) Inventor: Shinji Kano, Narashino-shi (JP)

(21) Appl. No.: 16/580,383

(22) Filed: Sep. 24, 2019

(30) Foreign Application Priority Data
Sep. 28, 2018 (JP) 2018-184986

(51) Int. Cl. G11B 27/034; H04N 5/232; G06K 9/00

(52) U.S. Cl. CPC G11B 27/034; G06K 9/00765; G06K 9/00744; H04N 5/232935

(57) ABSTRACT

An editing apparatus comprising at least one processor which function as: an acquiring unit configured to acquire a plurality of consecutive images imaged before and after an imaging instruction, an image imaged at a timing of the imaging instruction corresponding to a representative image; a designation unit configured to designate one or more images to be an editing target; and a control unit configured to control such that, in a case where the image corresponding to the representative image is included in the designated editing target images, the representative image is not changed, and to control such that, in a case where the image corresponding to the representative image is not included in the designated editing target images, the representative image is changed to an image corresponding to an image included in the designated editing target images.

### BACKGROUND OF THE INVENTION

### Field of the Invention

The present invention relates to an editing apparatus for controlling a representative image to be an appropriate image, a method of controlling the same, and a storage medium therefor.

### Description of the Related Art

In recent years, in imaging apparatuses such as digital cameras, those that employ an electronic shutter system instead of a mechanical shutter system have been increasing. By adopting an electronic shutter system, imaging speed can be improved and also image sensor reading speed can be improved, and in recent years, imaging apparatuses capable of consecutively imaging several tens of frames per second have been proposed.

There are systems in which, by utilizing such a function by which it is possible to image consecutively, a plurality of consecutive images before and after an imaging instruction are recorded when recording of an image is started when an imaging preparation instruction is received from the user, and in which the user is enabled to extract and save a desired image or a consecutive range.

In a case where a plurality of consecutive images are recorded as one file, it is desirable to be able to generate and display a representative image so that the content of the file can be easily ascertained. In a case where the user extracts an image or a consecutive range, it is necessary to appropriately update the representative image so that the image or the range after the extraction matches the representative image. Japanese Patent Laid-Open No. 2006-39753 proposes a technique by which it is possible to analyze frames selected from a plurality of frames included in a moving image and update a representative image.

However, in Japanese Patent Laid-Open No. 2006-39753, a technology is proposed in which in a case of selecting and saving multiple frames from a moving image file, the representative image is determined from an image section with the most similar feature amounts in the image, and there are cases in which updating will be performed unnecessarily even when it is not necessary to update the representative image. That is, there is the possibility that it will not be possible to update the representative image of the selected plural frames appropriately, and that an undesired frame will become the representative image.

### SUMMARY OF THE INVENTION

The present disclosure has been made in consideration of the aforementioned issues, and realizes a technique that, in a case where an image or a consecutive range is extracted from a plurality of images imaged consecutively, enables a corresponding representative image to be made to be an appropriate representative image.

In order to solve the aforementioned problems, one aspect of the present disclosure provides an editing apparatus comprising at least one memory and at least one processor which function as: an acquiring unit configured to acquire a plurality of consecutive images imaged before and after an imaging instruction, an image imaged at a timing of the imaging instruction corresponding to a representative image; a designation unit configured to designate one or more images to be an editing target, out of the plurality of images; and a control unit configured to control such that, in a case where the image corresponding to the representative image is included in editing target images designated by the designation unit, the representative image is not changed in an editing process, and to control such that, in a case where the image corresponding to the representative image is not included in editing target images designated by the designation unit, the representative image is changed in the editing process to an image corresponding to an image included in the editing target images designated by the designation unit.

Another aspect of the present disclosure provides, a method of controlling an editing apparatus, the method comprising: acquiring a plurality of consecutive images imaged before and after an imaging instruction, an image imaged at a timing of the imaging instruction corresponding to a representative image; designating one or more images to be an editing target, out of the plurality of images; and controlling such that, in a case where the image corresponding to the representative image is included in the designated editing target images, the representative image is not changed in an editing process, and controlling such that, in a case where the image corresponding to the representative image is not included in the designated editing target images, the representative image is changed in the editing process to an image corresponding to an image included in the designated editing target images.

Still another aspect of the present disclosure provides, a non-transitory computer-readable storage medium storing a program for causing a computer to execute a method of controlling an editing apparatus, the method comprising: acquiring a plurality of consecutive images imaged before and after an imaging instruction, an image imaged at a timing of the imaging instruction corresponding to a representative image; designating one or more images to be an editing target, out of the plurality of images; and controlling such that, in a case where the image corresponding to the representative image is included in the designated editing target images, the representative image is not changed in an editing process, and controlling such that, in a case where the image corresponding to the representative image is not included in the designated editing target images, the representative image is changed in the editing process to an image corresponding to an image included in the designated editing target images.

According to the present invention, in a case where an image or a consecutive range is extracted from a plurality of consecutively imaged images, a corresponding representative image can be made to be an appropriate representative image.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view illustrating an example of an external configuration of a digital camera as an example of an editing apparatus according to the present embodiment.

FIG. 2 is a block diagram illustrating an example of a functional configuration of the digital camera according to the present embodiment.

FIG. 3 is a flowchart illustrating a series of operations from activation to shutdown of the digital camera according to the present embodiment.

FIG. 4 is a flowchart illustrating a series of operations of playback mode processing according to the present embodiment.

FIGS. 5AA-5AF are views for explaining screen transitions in the playback mode according to the present embodiment.

FIGS. 5BA-5BE are views for explaining screen transitions in the playback mode according to the present embodiment.

FIGS. 6A-6F are views explaining a file configuration according to the present embodiment.

FIG. 7 is a flowchart illustrating a series of operations of group playback processing according to the present embodiment.

FIG. 8 is a flowchart illustrating a series of operations of file save process 1 according to the present embodiment.

FIG. 9 is a flowchart illustrating a series of operations of file save process 2 according to the present embodiment.

### DESCRIPTION OF THE EMBODIMENTS

### First Embodiment

Hereinafter, exemplary embodiments of the present invention will be described in detail with reference to the drawings. In the following description, as an example of an editing apparatus, a digital camera capable of extracting a plurality of images imaged consecutively before and after an imaging instruction will be described. However, the present embodiment may be a device capable of acquiring a plurality of images imaged by an external device and editing the acquired plurality of images. In addition, the present invention is not limited to a digital camera, and may include, for example, a personal computer, a PDA, a mobile phone terminal such as a smart phone, a portable image viewer, a digital photo frame, a music player, a game machine, a tablet terminal, an electronic book reader, and the like. Further, a watch-type or eyeglass-type information terminal, a medical device, an in-vehicle system such as a drive recorder, or the like may also be included.

### External Configuration of Digital Camera

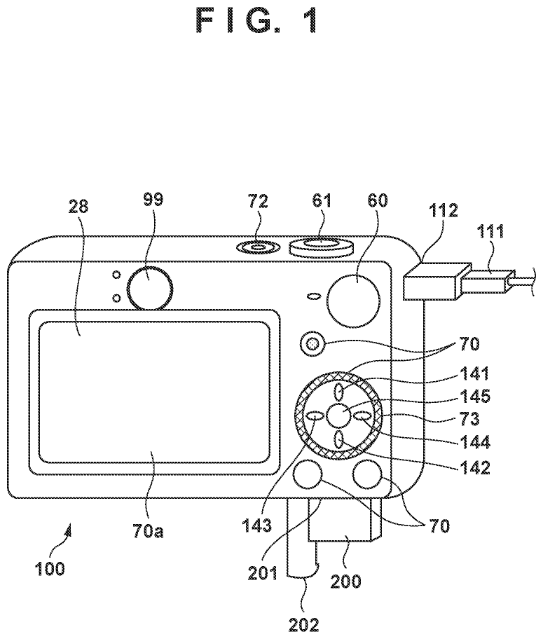

FIG. 1 illustrates an external view of a digital camera 100 as an example of a device to which the present invention can be applied. A display unit 28 includes, for example, a display device such as an LCD, and displays an image, a GUI for operating the digital camera 100, and various types of information. A shutter button 61 is a button for making an imaging instruction. A mode changeover switch 60 is a switch for switching various modes. The connector 112 is a connector between the digital camera 100 and a connection cable 111 for connecting to an external device such as a personal computer or a printer.

An operation unit 70 includes operation members such as various switches and buttons for receiving various operations from the user. A touch panel 70a is included in the operation unit 70, and enables a touch operation to be described later. The controller wheel 73 is an operation member that is rotatably operable and included in the operation unit 70. A 4-way directional button is included in the operation unit 70, and an up button 141, a down button 142, a left button 143, a right button 144, and a SET button 145 are configured.

A power switch 72 is a push button for switching between power on and power off. A storage medium 200 is a storage medium such as a memory card or a hard disk. A storage medium slot 201 is a slot for storing the storage medium 200. The storage medium 200 stored in the storage medium slot 201 can communicate with the digital camera 100, and recording thereon or playback therefrom are possible. The lid 202 is a lid of the storage medium slot 201. In the drawing, the lid 202 is opened, and a part of the storage medium 200 is taken out from the storage medium slot 201 and exposed.

### Functional Configuration of Digital Camera

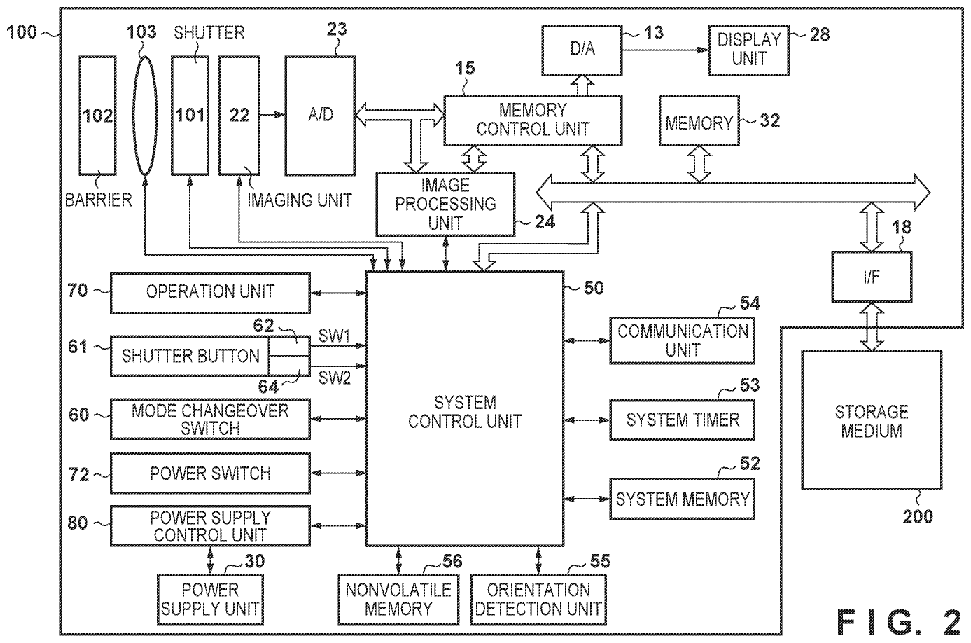

FIG. 2 is a block diagram illustrating an example of a functional configuration of a digital camera as an example of an editing apparatus according to the present embodiment. One or more of the functional blocks illustrated in FIG. 2 may be implemented by hardware such as an ASIC or a programmable logic array (PLA), or may be implemented by a programmable processor such as a central processing unit (CPU) or an MPU executing software. It may also be realized by a combination of software and hardware. Therefore, in the following description, even in a case where different functional blocks are described as the agents of operations, the same hardware can be used to realize the agents.

In FIG. 2, an imaging lens 103 is a lens group including a zoom lens and a focus lens. A shutter 101 is a shutter having an aperture function. An imaging unit 22 is an image sensor composed of CCDs, CMOS devices, and the like for converting optical images into electric signals. An A/D converter 23 converts analog signal output from the imaging unit 22 into a digital signal. A barrier 102 covers the imaging system including the imaging lens 103 of the digital camera 100, thereby preventing contamination and breakage of the imaging system including the imaging lens 103, the shutter 101, and the imaging unit 22.

An image processing unit 24 performs resizing processing such as predetermined pixel interpolation and reduction processing and color conversion processing on the image data from the A/D converter 23 or the image data from a memory control unit 15. In the image processing unit 24, predetermined arithmetic processing is performed using imaged image data, and a system control unit 50 performs exposure control and distance measurement control based on an obtained arithmetic result. Thereby, AF (Auto Focus) processing, AE (Auto Exposure) processing, and EF (Flash pre-emission) processing of the TTL (Through-the-Lens) method are performed. The image processing unit 24 further performs predetermined arithmetic processing using the imaged image data, and also performs automatic white balance (AWB) processing of the TTL method based on the obtained arithmetic result.

The image data from the A/D converter 23 is directly written into the memory 32 via the image processing unit 24 and the memory control unit 15 or via the memory control unit 15. The memory 32 stores image data obtained by the imaging unit 22 and converted into digital data by the A/D converter 23, and image data to be displayed on the display unit 28. The memory 32 has a storage capacity sufficient to store a predetermined number of still images and a predetermined time period's worth of moving images and sounds. The memory 32 also serves as memory (video memory) for displaying images.

The D/A converter 13 converts the image display data stored in the memory 32 into an analog signal and supplies the analog signal to the display unit 28. Thus, the image data for display written in the memory 32 is displayed on the display unit 28 via the D/A converter 13. The display unit 28 displays in accordance with an analog signal from a D/A converter 13 on a display device such as an LCD. A digital signal resulting from A/D conversion by the A/D converter 23 and stored in the memory 32 is analog-converted by the D/A converter 13, and sequentially transferred to the display unit 28 for display, thereby functioning as an electronic viewfinder and enabling a through-image display (live view display).

A nonvolatile memory 56 is a memory as an electrically erasable/recordable storage medium, and, for example, an EEPROM or the like is used. The nonvolatile memory 56 stores constants, programs, and the like for the operation of the system control unit 50. Here, the programs include computer programs for executing various flowcharts described later in the present embodiment.

The system control unit 50 is a control unit having at least one processor, and controls the entire digital camera 100. Programs recorded in the nonvolatile memory 56 described above are loaded into the system memory and executed, thereby realizing each process of the present embodiment described later. A RAM is used as the system memory 52. The system memory 52 temporarily stores constants and variables for the operation of the system control unit 50, programs read from the nonvolatile memory 56, and the like. The system control unit 50 controls the memory 32, the D/A converter 13, the display unit 28, and the like to perform display control.

A system timer 53 is a timer unit that measures the time used for various controls and the time of a built-in clock.

The mode changeover switch 60, the shutter button 61, and the operation unit 70 are operation units for inputting various operation instructions to the system control unit 50. The mode changeover switch 60 switches the operation mode of the system control unit 50 to either a still image recording mode, a moving image imaging mode, or a playback mode. Modes included in the still image recording mode include an auto-imaging mode, an automatic scene determination mode, a manual mode, an aperture priority mode (Av mode), and a shutter speed priority mode (Tv mode). Also included are various scene modes, program AE modes, custom modes, and the like, which are imaging settings for each imaging scene. The user can directly switch to any of these modes by operating the mode changeover switch 60. Alternatively, after the user once switches to an imaging mode list screen with the mode changeover switch 60, the user may select one of the plurality of displayed modes and perform the changeover using another operation member. Similarly, the moving image imaging mode may include a plurality of modes.

A first shutter switch 62 is turned on during operation of the shutter button 61 provided in the digital camera 100 by a so-called half press (imaging preparation instruction) to generate a first shutter switch signal SW 1. The system control unit 50 starts operations such as AF (auto-focus) processing, AE (automatic exposure) processing, AWB (auto-white balance) processing, and EF (flash pre-emission) processing by the first shutter switch signal SW 1.

A second shutter switch 64 is turned on when the shutter button 61 has been operated completely and a so-called full press (imaging instruction) is performed to generate a second shutter switch signal SW 2. In a case of imaging one still image, the system control unit 50 starts a series of imaging process operations from reading of a signal from the imaging unit 22 to writing of image data to the storage medium 200 by the second shutter switch signal SW 2.

Each operation member of the operation unit 70 is assigned a function as appropriate for each scene according to, for example, selection and operation of various function icons displayed on the display unit 28, and acts as various function buttons. Function buttons include, for example, an exit button, a return button, image scrolling buttons, jump buttons, a narrow-down button, an attribute change button, and the like. For example, when a menu button is pressed, various settable menu screens are displayed on the display unit 28. The user can intuitively perform various settings using the menu screen displayed on the display unit 28 and the buttons 141 to 144 and the SET button 145 of the 4-way directional button.

The controller wheel 73 is a rotatably operable operation member included in the operation unit 70, and is used when instructing a selection item, together with the direction buttons. When the controller wheel 73 is rotated, an electric pulse signal is generated in accordance with the operation amount, and the system control unit 50 controls respective units of the digital camera 100 based on the pulse signal. The angle at which the controller wheel 73 is rotated, the number of rotations, and the like can be determined by the pulse signal. Note that the controller wheel 73 may be any operation member as long as a rotation operation thereon can be detected. For example, the controller wheel 73 itself may be a dial operation member that is rotated in response to a rotation operation of the user to generate a pulse signal. Alternatively, the controller wheel 73 may be such that it does not rotate itself but rather detects a rotation operation or the like of a finger of the user on the controller wheel 73 by a touch sensor operation member (a so-called touch wheel).

A power supply control unit 80 is configured by a battery detection circuit, a DC-DC converter, a switch circuit for switching between blocks to be energized, and the like, and detects whether or not a battery is mounted, the type of the battery, and the remaining battery level. In addition, the power supply control unit 80 controls a DC-DC converter based on the detected results and instructions from the system control unit 50, and supplies the required voltages to the respective units including the storage medium 200 for the required periods of time.

A power supply unit 30 is configured by a primary battery such as an alkaline battery or a lithium battery, a secondary battery such as a NiCd battery or a NiMH battery, a Li battery, an AC adapter, or the like. A storage medium I/F 18 is an interface with a storage medium 200 which is a memory card or a hard disk. The storage medium 200 is a storage medium such as a memory card for recording imaged images, and is configured by a semiconductor memory, an optical disk, a magnetic disk, or the like.

A communication unit 54 is connected wirelessly or by a wired cable, and performs transmission and reception of video signals, audio signals, and the like. The communication unit 54 can also be connected to a wireless LAN (Local Area Network) or the Internet. The communication unit 54 can transmit an image imaged by the imaging unit 22 (including a through image) and an image recorded on the storage medium 200, and can receive image data and other various information from an external device.

An orientation detection unit 55 detects the orientation of the digital camera 100 with respect to the direction of gravity. Based on the orientation detected by the orientation detection unit 55, it is possible to determine whether an image imaged by the imaging unit 22 is an image imaged with the digital camera 100 set up horizontally or vertically. The system control unit 50 can add orientation information corresponding to the orientation detected by the orientation detection unit 55 to the image file of the image imaged by the imaging unit 22, or can record the image after rotating the image. As the orientation detection unit 55, an acceleration sensor, a gyro sensor, or the like can be used.

The operation unit 70 comprises the touch panel 70a, which is capable of detecting contact with the display unit 28 as one member. The touch panel 70a and the display unit 28 may be integrally formed. For example, the touch panel 70a is configured so that its light transmittance does not hinder the display of the display unit 28, and is attached to the upper layer of the display surface of the display unit 28. Also, input coordinates on the touch panel 70a are associated with display coordinates on the display unit 28. As a result, it is possible to configure a graphical user interface (GUI) such that the user can directly operate the screen displayed on the display unit 28. The system control unit 50 can detect the following operations/states on the touch panel 70a.
A finger or pen that has not touched the touch panel 70a newly touches the touch panel 70a. That is, a touch starts (hereinafter referred to as touch-down (Touch-Down)).
The touch panel 70a is in a state of being touched with a finger or a pen (hereinafter referred to as touch-on (Touch-On)).
The finger or pen is being moved while being kept touched against the touch panel 70a (hereinafter referred to as touch-move (Touch-Move)).
The finger or pen that was touching the touch panel 70a was released. That is, a touch ends (hereinafter referred to as touch-up (Touch-Up)).
The touch panel 70a is in a state of not being touched by anything (hereinafter referred to as touch-off (Touch-Off)).

When a touch-down is detected, a touch-on is also detected at the same time. After the touch-down, the touch-on usually continues to be detected as long as no touch-up is detected. Detection of a touch-move is also a state in which a touch-on is being detected. Even if the touch-on is detected, if the touch position is not moved, the touch-move is not detected. After the touch-up of all fingers and pens that have been touched is detected, it becomes a touch-off.

The system control unit 50 is notified, via the internal bus, of these operations and states and the position coordinates at which a finger or a pen is touching on the touch panel 70a. The system control unit 50 determines what kind of operation (touch operation) is performed on the touch panel 70a based on the notified information. With respect to a touch-move, a movement direction of the finger or the pen moving on the touch panel 70a can also be determined for each of the vertical component and the horizontal component on the touch panel 70a based on the change in the position coordinates. In a case where it is detected that the touch-move has been performed by a predetermined distance or more, configuration is such that it is determined that a slide operation has been performed. An operation of moving a finger quickly by a certain distance while touching the touch panel and simply releasing the finger is called a flick. In other words, a “flick” is an operation of quickly flicking a finger on the touch panel 70a. If it is detected that a touch-move of a predetermined distance or more was performed at a predetermined speed or more and the touch-up is detected as is, it can be determined that a flick has been performed (it can be determined that a flick has occurred following a slide operation). Further, a touch operation in which a plurality of points (e.g., two points) are touched at the same time to bring the touch positions closer to each other is referred to as a pinch-in operation, and a touch operation in which the touch positions move away from each other is referred to as a pinch-out operation. Pinch-out and pinch-in are collectively referred to as pinch operations (or simply pinching). The touch panel 70a may be a touch panel of any of various types such as a resistive film type, an electrostatic capacitance type, a surface acoustic wave type, an infrared type, an electromagnetic induction type, an image recognition type, and an optical sensor type. Depending on the type, there are methods of detecting that there has been a touch because there has been a contact with the touch panel, and methods of detecting that there has been a touch because a finger or a pen has approached the touch panel, but any method may be used.

### Series of Operations Related to Activation and Shutdown of the Digital Camera

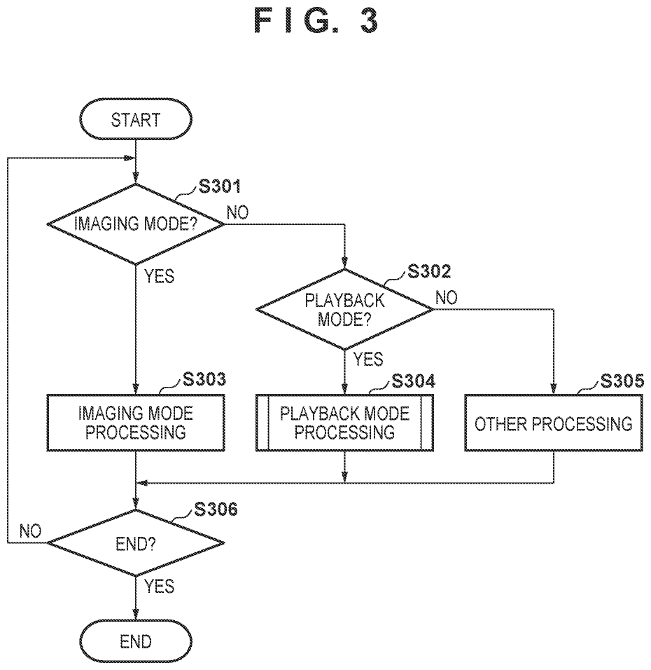

Next, with reference to FIG. 3, basic operation related to activation and shutdown of the digital camera will be described. This operation is performed, for example, after the power switch 72 is pressed to activate the digital camera. This operation is realized by the system control unit 50 loading and executing the program stored in the nonvolatile memory 56 into the work area of the system memory 52, and controlling each unit such as the image processing unit 24.

In step S301, the system control unit 50 determines whether or not it is the imaging mode. The system control unit 50 proceeds to step S303 in a case where it is determined that it is the imaging mode based on the position of the mode changeover switch 60, and proceeds to step S302 when it is determined that it is not the imaging mode.

In step S302, the system control unit 50 determines whether or not it is the playback mode. The system control unit 50 proceeds to step S304 in a case where it is determined that it is the playback mode based on the position of the mode changeover switch 60, and proceeds to step S305 when it is determined that it is not the playback mode.

In step S303, the system control unit 50 performs processing of the imaging mode. The processing in the imaging mode includes still image imaging, moving image imaging, and the like. In step S304, the system control unit 50 performs processing of the playback mode. In the playback mode processing, the system control unit 50 mainly displays, deletes, or edits an imaged still image or moving image. The playback mode processing of the present embodiment includes a group playback process for displaying the content of group-RAW-data, which will be described later.

In step S305, the system control unit 50 performs other processing. The other processing referred to here includes processing in a clock display mode in which only the current time is displayed. When the processing of the respective modes is completed, the system control unit 50 proceeds to step S306 and determines whether or not to shut down camera operation. For example, in a case where it is determined that the shutdown is to be performed upon detection of the pressing of the power button or the like, this operation is terminated. In a case where it is determined that the shutdown is not to be performed, the processing returns to step S301 and step S301 and subsequent processes are repeated.

### Series of Operations Pertaining to Playback Mode Processing

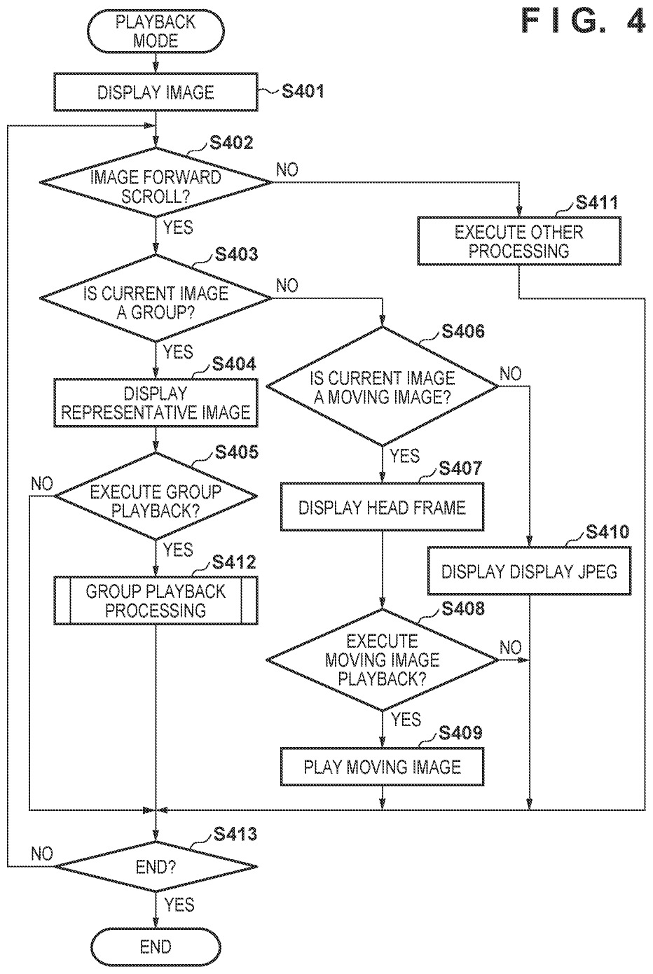

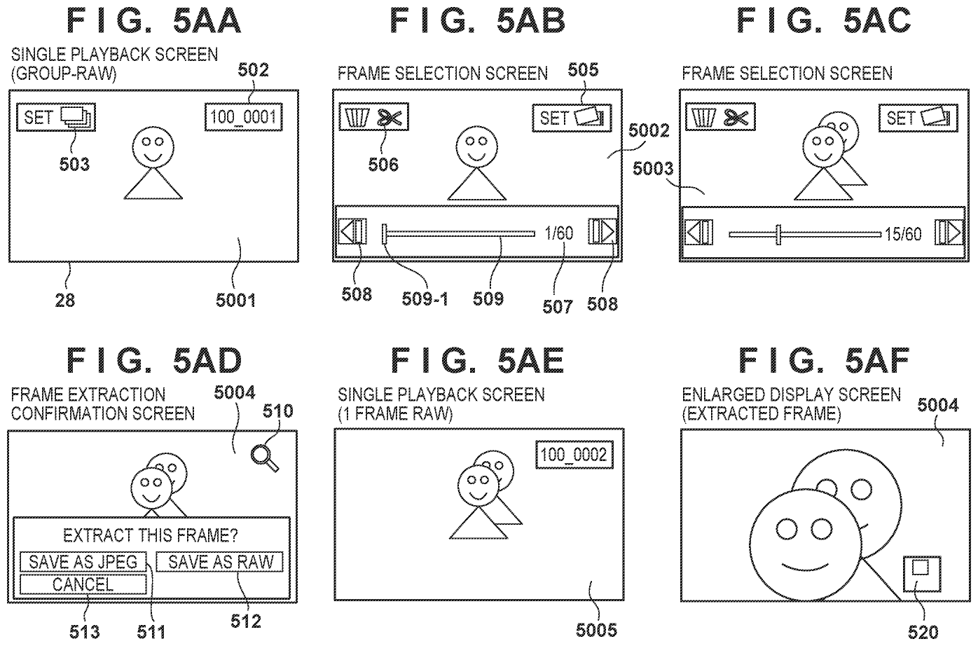

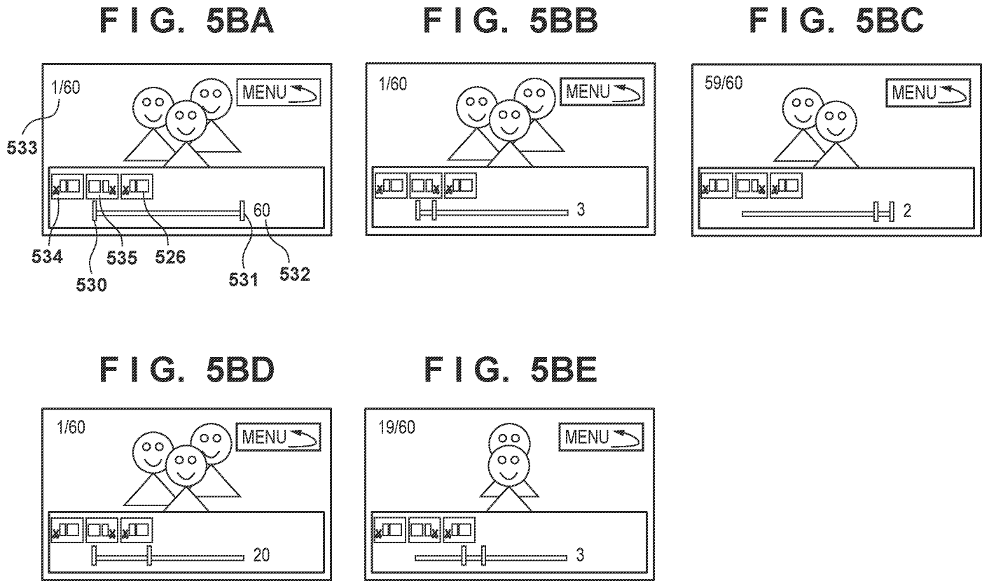

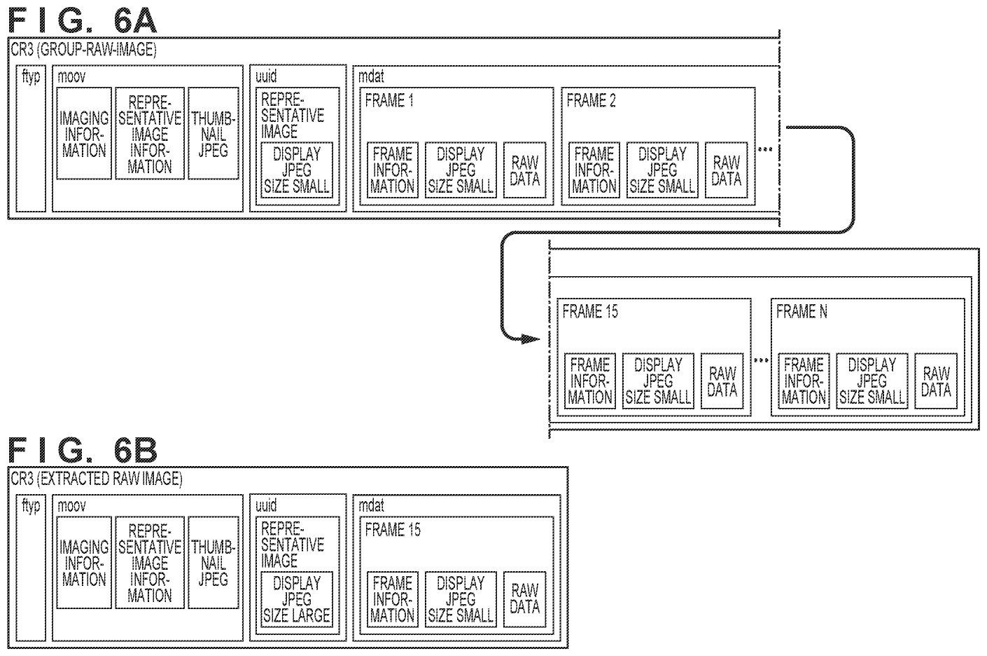

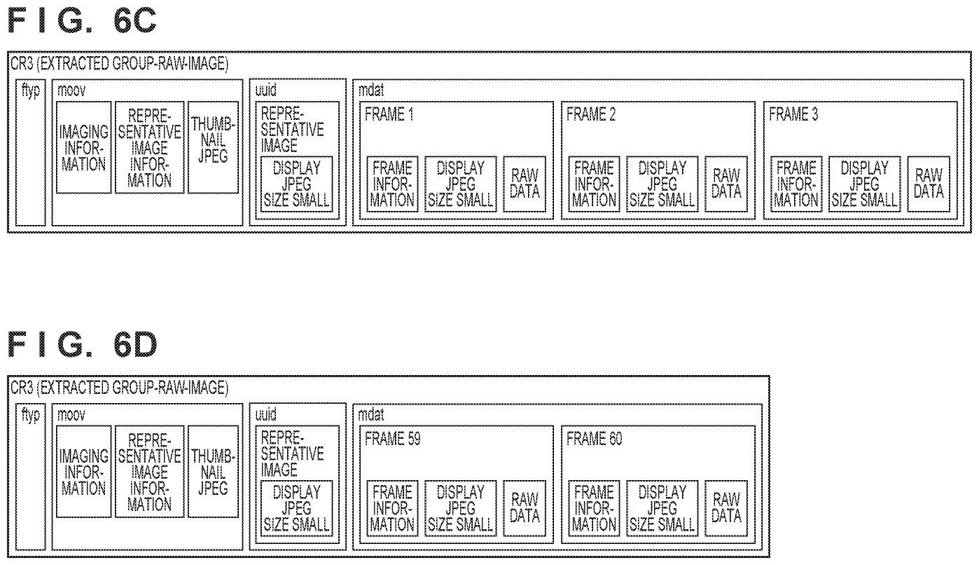

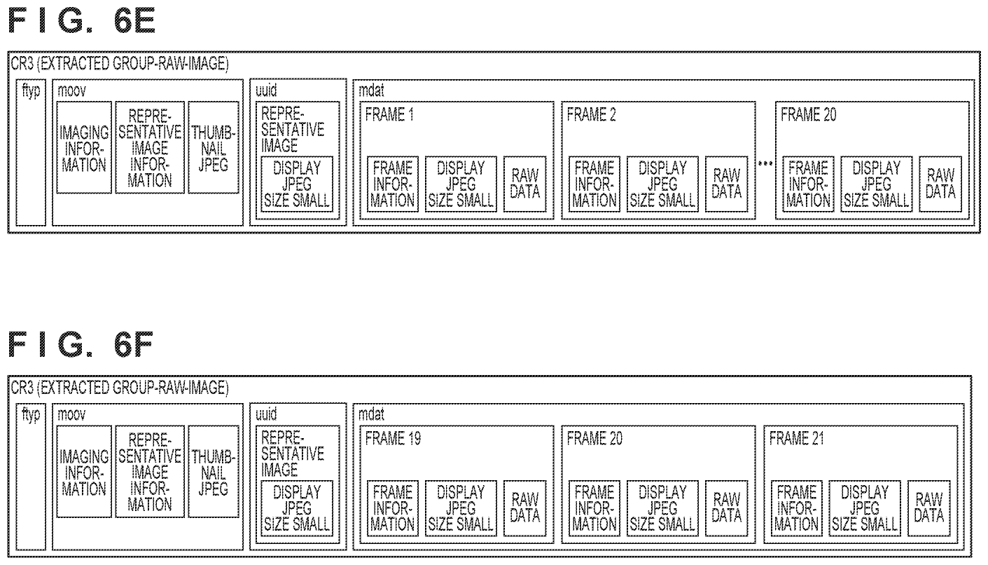

Next, a series of operations relating to the playback mode processing in step S304 illustrated in FIG. 3 will be described. Note that the playback mode processing according to the present embodiment includes an editing operation in the playback mode of the digital camera 100, in which the content of group-RAW-data, which will be described later, is browsed, frames to be saved are designated from the group, and a file is saved. This playback mode processing will be described with reference to the flowcharts of FIGS. 4 and 7 to 9, the screen transition view of FIG. 5, and the file configuration view of FIGS. 6A to 6F

Prior to a specific description of the playback mode processing, problems relating to group-RAW-data and a representative image thereof will be described first. In order to realize imaging of several 10s of frames (for example, 30 frames) per second at the time of imaging, the digital camera 100 employs a method to save processing time by abridging JPEG compression processing and file creation processing, which are post-imaging processes. At this time, each piece of frame data of 30 frames per second is left as raw data (RAW data), and JPEG compression processing is not performed. Since the thumbnail data for display is necessary even in a case of leaving the frame data as RAW data, thumbnail data of a recording size smaller than the size at the time of imaging is embedded in each frame. Here, data generated by combining the data of a plurality of frames into one file is referred to as group-RAW-data or a group-RAW-image (the details of the data will be described later with reference to FIGS. 6A-6F separately).

To allow the user to easily browse group-RAW-images, representative images of the group-RAW-images are generated. Even in a case where the group-RAW-image is edited, it is desirable that an appropriate representative image is set for the edited group-RAW-image. More specifically, for example, when a group-RAW-image is generated (that is, at imaging), a thumbnail or a display image of a frame at a time when SW 2 is pressed can be recorded as a representative image. In the imaging of a group-RAW-image, images are pre-recorded during the pressing of the SW 1, and the images during the pressing of the SW 1 and the images during the pressing of the SW 2 are collectively included in the group-RAW-image. There are cases where for a group-RAW-image generated in this manner, in a case of editing/saving when a plurality of frames are designated from the group-RAW-image, a position of a representative image set in advance is not included in the designated range. Therefore, it is necessary to appropriately update the representative image to correspond to the designated range after editing.

Next, with reference to FIG. 4, description is given for playback mode processing according to the present embodiment. Similar to FIG. 3, the playback mode processing is realized by the system control unit 50 loading a program stored in the nonvolatile memory 56 into the memory 32 and executing the program.

In step S401, the system control unit 50 reads a particular image file from the storage medium 200, and displays an image of the read image file on the entire display unit 28. In step S402, the system control unit 50 determines whether or not image forward scrolling operation was performed. The system control unit 50 proceeds to step S403 in a case where it is determined that image forward scrolling operation has been performed based on a signal from the operation unit 70, and otherwise proceeds to step S411.

In step S403, the system control unit 50 determines whether or not the data format of the image file (current image) displayed on the display unit 28 is group-RAW-image file image. In a case where it is determined that the current image is a group-RAW-image file image, the system control unit 50 proceeds to step S404 and otherwise proceeds to step S406.

In step S404, the system control unit 50 causes the display unit 28 to display a representative image of the group-RAW-image file as a single playback screen. In this S404, a single playback screen as illustrated in FIG. 5AA is displayed. In the single playback screen of FIG. 5AA, a representative image 5001 of the group-RAW-data is displayed. Further, in order to identify the image file being read from the storage medium 200, the file number 502 is also displayed as an OSD. The navigation guide 503 displayed on the single playback screen is guidance used to both identify a group image, and to enable the user to browse the contents of the group-RAW-image by pressing a SET button on the display unit 28.

Referring now to FIG. 6A, the file configuration of group-RAW-data will be described in detail. Here, a case where the number of frames of the group-RAW-data is N=60 will be described as an example. The group-RAW-data is generated when, in the imaging mode, the shutter button is pressed in a predetermined imaging mode, and it is assumed that 30 frames per second can be captured as a RAW file while the shutter button is pressed. Since RAW data is being captured at 30 frames per second, it may be difficult, due to the CPU processing speed, to convert the RAW file into JPEG at high image quality and size (size: large) by performing one by one a development process at the time of imaging. Therefore, in the present embodiment, it is assumed that the processing is abridged so as to perform minimal development processing for a display JPEG of a size (size: small) smaller than the above-mentioned size at the time of imaging. The group-RAW-image illustrated in FIG. 6A represents a file generated under such a condition.

An ftyp box, a moov box, a uuid box, and an mdat box are included as file configurations. A file type is described in the ftyp box, and one is included at the head of the file.

The moov box is a container containing meta-information and one is included the file. The meta information includes information of the moving image data imaging date/time and imaging conditions, a thumbnail image, and the like. The moov box may further include a plurality of boxes, and the meta information may be stored in the moov box divided across the boxes for each type of meta information. In the example of FIG. 6A, imaging information, representative image information, and a thumbnail JPEG are included. The uuid box includes a representative image and the like. The representative image includes display JPEG data for the representative image of the entire group.

One file may include a plurality of mdat boxes. However, in the digital camera 100 of the present embodiment, when a file is generated, only one mdat box is provided in one file, and image data, audio data, and the like are stored in the mdat box. In the example illustrated in FIG. 6A, as image data, information of respective frames such as frame information of the first frame, a display JPEG (size: small), and RAW data thereof, frame information of the second frame, a display JPEG (size: small), and RAW data thereof are sequentially included. Also, the configuration is such that frame information, the display JPEG (size: small), and the RAW data of the last 60 frames are included. That is, for the group-RAW-data, the shutter button was kept pressed down for 2 seconds at the time of imaging, and an image displayed in FIG. 5AA is a representative image of the group-RAW-image files illustrated in FIG. 6A. The display images of the first frame and the second frame will be described later in the group playback processing.

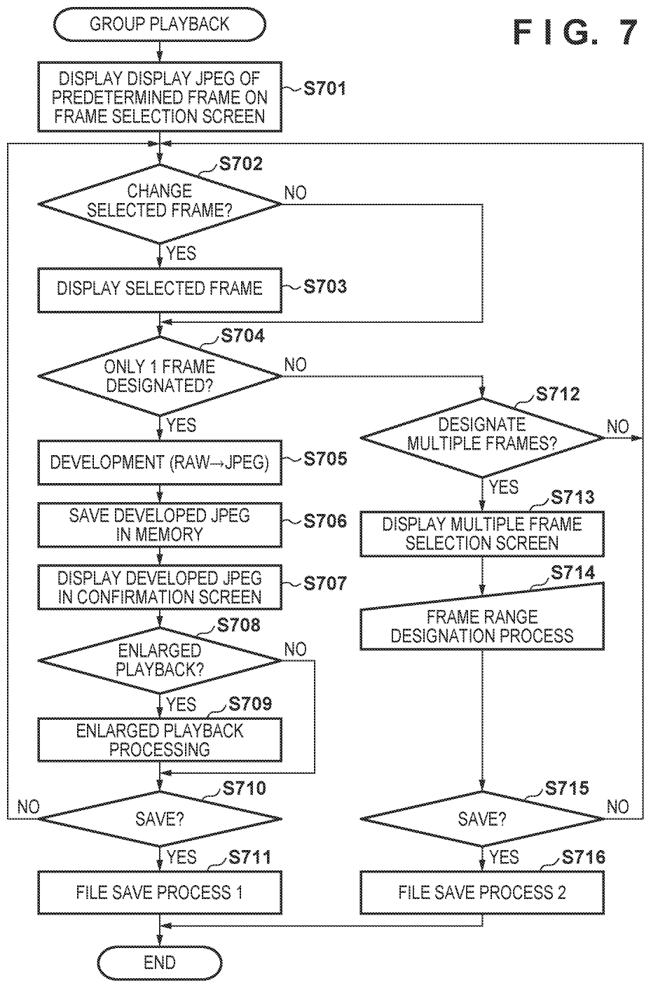

In step S405, the system control unit 50 determines whether or not an instruction to execute group playback was made. Here, an instruction to execute group playback can be given by pressing the SET button, as illustrated in the navigation guide 503, and the system control unit 50 determines that execution is instructed in response to the detection of an operation on the SET button, and proceeds to the group playback processing. Alternatively, group playback processing may be executed upon detection of the user making a touch operation on the navigation guide 503 on the single playback screen of FIG. 5AA. As described above, in a case where it is determined that the execution of the group playback is instructed, the system control unit 50 proceeds to step S412 and otherwise proceeds to step S413. In step S412, the system control unit 50 performs group playback processing. The group playback processing will be described later with reference to FIG. 7.

In step S406, the system control unit 50 further determines whether an image (i.e., a current image) displayed on the display unit 28 is an image of a moving image file (since the current image is not a group-RAW-image). In a case where it is determined that the current image is a moving image file image, the system control unit 50 proceeds to step S407 and otherwise proceeds to step S410.

In step S407, the system control unit 50 causes the display unit 28 to display the head frame of the moving image file on the single playback screen. In step S408, the system control unit 50 determines whether or not an instruction to execute moving image playback has been issued based on a signal from the operation unit 70. In a case where it is determined that there is an instruction to execute moving image playback, the process proceeds to step S409, otherwise, the process proceeds to step S413. In step S409, the system control unit 50 performs moving image playback processing. The moving image referred to here may be a moving image with RAW data or a moving image without RAW data.

In step S410, the system control unit 50 displays on the single playback screen a still image JPEG for display for the image file where the current image is an image file that is neither a moving image file image nor a group-RAW-image file image. In step S411, the system control unit 50 performs processing other than image scrolling whose execution can be instructed on single playback screen of the playback mode (since an operation other than image scrolling has been received). The other processing referred to here includes processing for enlarging an image and for actuating a function for erasing an image. In step S413, the system control unit 50 determines whether or not the playback mode is to be terminated. In a case where it is determined that the playback mode is to be terminated, the system control unit 50 terminates the playback mode and then ends this operation. Meanwhile, in a case where it is determined that the termination is not to be performed, the processing returns to step S402 and step S402 and subsequent processes are repeated.

### Series of Operations Pertaining to Group Playback Processing

Next, referring to FIG. 7, a series of operations relating to the group playback processing of the present embodiment in the above-described step S412 will be described. Similar to the operation illustrated in FIG. 4, this group playback processing is realized by the system control unit 50 loading a program stored in the nonvolatile memory 56 into the memory 32 and executing the program.

In step S701, the system control unit 50 displays, on the display unit 28, the display JPEG for the frame that is set as the representative image frame in the group-RAW-image file for which the group playback was selected in step S404, as a frame selection screen as in FIG. 5AB. The process then proceeds to step S702. In the frame selection screen, the image of the content of the processing-target group-RAW-image file is browsed on the frame selection screen, and one frame to be a processing target of extraction processing can be selected in accordance with an operation of the user.

In step S702, the system control unit 50 determines whether or not there has been an operation for changing the selected frame (display frame), and in a case where there has been an operation for changing the selected frame, the system control unit 50 changes the image to be displayed on the frame selection screen to the selected frame and displays that image in step S703. The frame selection screen and the change of the selected frame will be described with reference to FIG. 5AB and FIG. 5AC.

FIG. 5AB illustrates a display state when the frame selection screen is transitioned to in step S701, and when the frame selection screen is transitioned to, the frame of the representative image of the group-RAW-image is displayed. FIG. 5AB illustrates a case where the representative image frame is the first frame. Therefore, in the frame selection screen of FIG. 5AB, a display image 5002 displays the display JPEG of a frame 1 of FIG. 6A. The navigation guide 505 in FIG. 5AB is an execution guide for extracting just the one frame displayed on the display unit 28. It is possible to extract only the one frame (5002) by a touch operation on that portion. Also, the navigation guide 506, unlike the navigation guide 505, is a guide for collectively extracting a plurality of frames at once, and when a touch operation is performed on that guide, a multiple frame selection screen of FIG. 5BA is transitioned to. Also, frame forward/backward scroll buttons 508 at the bottom of the screen are touch buttons by which it is possible to perform frame forward/backward scrolling by touch operations. By performing a touch operation on the right frame forward scroll button 508, it is possible to advance the frame by one, and by operating the left frame backward scroll button 508 it is possible to scroll the frame backwards by one. It is also possible to change the frame displayed on the frame selection screen by touching a pointer 509-1 indicating the frame position of the currently displayed frame in a seek bar 509 and then performing a drag operation. That is, in step S702, an operation on one of the frame forward/backward scroll buttons 508 or the pointer 509-1 is detected, and in a case where a touch operation is performed on these operation items, the image to be displayed on the frame selection screen is changed. The information display 507 indicates the number of the frame in the group (the total number of frames) currently being browsed. Since the total number of frames is 60 and the first frame is currently being browsed, it is displayed as “1/60”.

When a touch operation is performed on the frame forward scroll button 508 on the frame selection screen of FIG. 5AB, the frame is scrolled from the first frame to the second frame. At this time, the information display 507 is displayed as “2/60”. The image displayed on the frame selection screen becomes the display JPEG for the frame 2 in FIG. 6A. In this step S703, since the display JPEG displayed on the frame selection screen is a small-sized image, smooth frame selection is enabled. FIG. 5AC illustrates a situation in which the 15th out of 60 frames in the group-RAW-image file is selected on the frame selection screen, and the display JPEG image for the 15th frame image is displayed as the display image 5003.

In step S704, the system control unit 50 determines whether or not a single frame is selected as the frame that is to be the target of extraction processing on the frame selection screen. Specifically, in a case where the SET button is operated or the navigation guide 505 is touched in a state where the selected frame is displayed on the frame selection screen, it is determined that a single frame is selected as a frame to be the processing target in the extraction processing. In a case where one frame is selected, the processing proceeds to step S705; otherwise, the processing proceeds to step S712.

In step S705, the system control unit 50 reads the RAW data in the group-RAW-image file corresponding to the frame selected as the extraction processing target on the frame selection screen from the storage medium 200, and the image processing unit 24 performs a development process on the read RAW image. By this development process, a JPEG image (size: large) after development having a resolution larger than that of the display JPEG is generated. In step S705, not only the development process but also the process of converting the image data after development into the JPEG format is performed. In step S706, the system control unit 50 temporarily stores the JPEG image generated in step S705 in the memory 32. Then, in step S707, the system control unit 50 displays the frame selected as the extraction processing target on the frame selection screen at higher image quality than the frame selection screen, and displays a confirmation screen on the display unit 28 for confirming, with the user, whether the extraction processing is to be executed. In this confirmation screen, a display image based on the developed JPEG image generated in step S705 is displayed.

The confirmation screen will be described with reference to FIG. 5AD. First, the development process will be described in detail. The display image displayed on the display unit 28 in the frame selection screen is a display JPEG (size: small) corresponding to the selected frame among a plurality of images recorded in the group-RAW-image files of FIG. 6A. In a case where an operation instruction for extracting the displayed frame as a single image is detected in step S704, RAW data corresponding to the selected frame among a plurality of images recorded in the group-RAW-image file of FIG. 6A becomes a target of the development process in step S705. In step S705, the development process is performed on the basis of parameters at the time of imaging included in the raw data. In this development process, a development process is performed so as to have a size for which the resolution is larger than that of the size of the display image 5003 and the display JPEG stored in the group-RAW-image file, and a conversion into a JPEG format to generate the JPEG image after development. Then, a display image 5004 based on the developed JPEG image is displayed as a confirmation screen. As illustrated in FIG. 5AD, in addition to the display image 5004, an execution guide or the like is displayed on the confirmation screen. The execution guide includes an enlargement guide 510 and guides for saving (JPEG save execution 511, RAW save execution 512, and cancellation). That is, the confirmation screen indicates that the image can be enlarged by performing an enlargement operation, and that when a save guide is touched and the saving is executed, the selected frame can be extracted and save processing for saving a new image file is transitioned to. After the confirmation screen is displayed in step S707, the processing proceeds to step S708.

In step S708, the system control unit 50 determines whether an enlargement operation for performing an enlargement process has been performed, that is, whether the enlargement guide 510 has been touched. In a case where an operation for enlargement processing is performed, the processing proceeds to step S709; otherwise, the processing proceeds to step S710.

In step S709, the system control unit 50 performs enlarged playback processing. In the enlarged playback processing, the JPEG image 5004 generated in the above-described step S704 and stored in the memory 32 is displayed on the display unit 28 in an enlarged state (enlarged display) as illustrated in FIG. 5AF. Since the JPEG image 5004 is generated by performing high image quality development, it is suitable for checking whether or not the image is in focus. To indicate the enlarged playback state, an enlarged position indicator 520 is displayed on the display unit 28. The process then proceeds to step S710. In the frame selection screen, since the display image is being displayed using a small-sized image, the enlarged display is not possible, but in the frame confirmation screen, a developed JPEG image of high image quality is used for display, so enlarged display is possible.

In step S710, the system control unit 50 determines whether or not to extract the one frame selected in step S702 and save a file. On the confirmation screen, in a case where a touch operation on the save guide is detected, the process proceeds to step S711 to save the file, otherwise, the process returns to step S702.

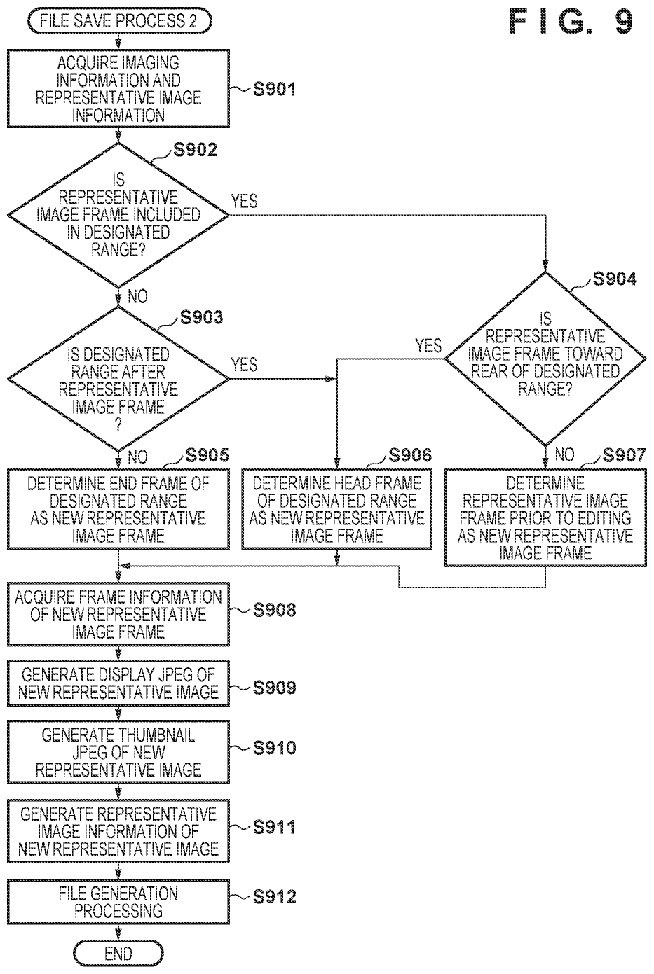

In step S711, the system control unit 50 performs file save process 1 in which one frame selected on the frame selection screen is extracted and recorded as a new image file. The file save process 1 will be described separately later with reference to FIG. 9.

In step S712, the system control unit 50 determines whether or not an operation for selecting a plurality of frames has been performed on the frame selection screen. In a case where a touch operation is performed on the navigation guide 506 in the frame selection screen, the system control unit 50 determines that an operation was performed to select a plurality of frames, and the system control unit 50 proceeds to step S713; otherwise, the system control unit 50 returns to step S702.

In step S713, the system control unit 50 causes the display unit 28 to display a multiple frame selection screen for selecting a plurality of frames as illustrated in FIG. 5BA. In the multiple frame selection screen, by designating the start point and end point frames with respect to the frames in the group-RAW-image file in response to touch operations by the user, it is possible to designate the plurality of frames between the designated ones as an extraction target frame range.

In step S714, the system control unit 50 receives the selection of the frame range in the multiple frame selection screen by a touch operation from a user. The operation method of frame range selection will be described. When a touch operation is made on a front frame designation button 534 in the multiple frame selection screen, the pointer 530 enters a focus state, and thereafter, the pointer 530 is moved by a touch operation, whereby the start point frame can be selected. Also, similarly, when a touch operation is made on a back frame designation button 535 in the multiple frame selection screen, the pointer 531 enters a focus state, and thereafter, the pointer 531 is moved by a touch operation, whereby the end point frame can be selected. The information display 532 indicates the number of frames being selected. After the selection of the frame range from the user is accepted, the process proceeds to step S714.

In the multiple frame selection screen illustrated in FIG. 5BB, the start point frame is the first frame, the end point frame is the third frame, and so three frames are selected. In the multiple frame selection screen illustrated in FIG. 5BC, the start point frame is the 59th frame, the end point frame is the 60th frame, and so two frames are selected. In the multiple frame selection screen illustrated in FIG. 5BD, the start point frame is the first frame, the end point frame is the 20th frame, and so 20 frames are selected. In the multiple frame selection screen illustrated in FIG. 5BE, the start point frame is the 19th frame, the end point frame is the 21st frame, and so three frames are selected.

In step S715, the system control unit 50 determines whether or not an operation for extracting the plurality of frames of the range designated in step S714 and saving a file was made. In a case where an operation for saving the file was performed, the processing proceeds to step S716; otherwise, the processing returns to step S702. Here, the operation of saving the file is a touch operation on the save button 526 of the multiple frame selection screen in FIG. 5BD.

In step S716, the system control unit 50 extracts the multiple frames selected in step S714 and performs file save process 2. The file save process 2 will be described later with reference to FIG. 9. When the file save process 2 ends, the group playback processing ends. When the group playback is completed, a representative image of the group-RAW-image file recorded in step S716 in the file save process 2 is displayed as a single playback screen on the display unit 28.

### Series of Operations Pertaining to File Save Process

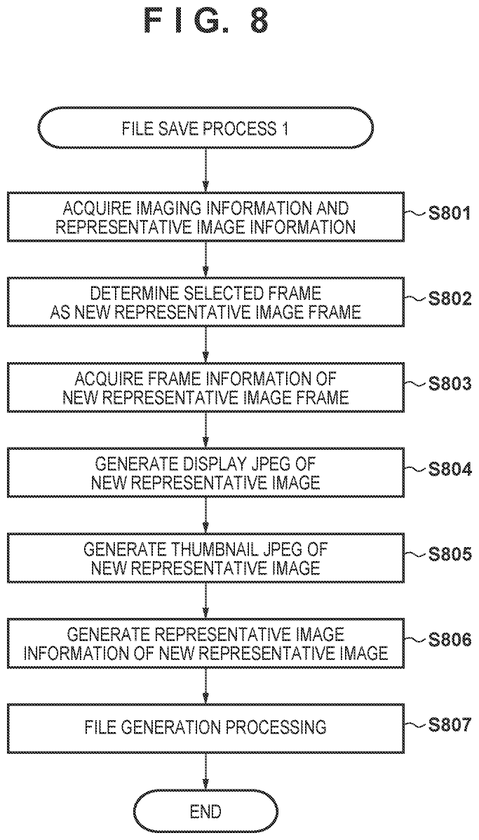

Next, referring to FIG. 8, a series of operations of the file save process 1 in which the number of images in the range of editing target images is one will be described. Similar to the processing of FIG. 7, the file save process is realized by the system control unit 50 loading a program stored in the nonvolatile memory 56 into the memory 32 and executing the program.

In step S801, the system control unit 50 acquires the imaging information and the representative image information in the group-RAW-image, and temporarily stores them in the memory 32. The imaging information is information including an imaging start time, lens information at the time of imaging, and the like. The representative image information is information including the frame number, the imaging date and time, the resolution of the representative image, and the like of the frame in the group-RAW-image corresponding to the representative image.

In step S802, the system control unit 50 determines the frame designated in step S702 as a new representative image frame. In the examples illustrated in FIG. 5AD, the new representative image frame is the frame 15 displayed as display image 5004 on the display unit 28.

In step S803, the system control unit 50 acquires frame information of the new representative image frame from the group-RAW-image, and temporarily stores it in the memory 32. In the case of FIG. 5AD, the frame information of the frame 15 of FIG. 6A is acquired.

In step S804, the system control unit 50 acquires RAW data of the new representative image frame from the RAW file, and performs a development process for generating a display JPEG (size: large) therefrom. The developed JPEG (size: large) is temporarily stored in the memory 32. First, the development process will be described in detail. In a case where the frame confirmation screen of FIG. 5AD is being displayed on the display unit 28, the display image 5004 is an image of the frame 15 of FIG. 6A. Since an operation instruction for extracting the frame 15 as a single image was performed, the RAW data that is the development target is the RAW data of the frame 15 in FIG. 6A. The system control unit 50 performs a development process on the RAW data of the frame 15 based on the imaging information acquired in step S801 and the frame information of the frame 15 acquired in step S803. In this development process, a development process is performed at a size larger than the display JPEG of the frame 15 to generate a display JPEG image (size: large) and temporarily store it in the memory 32.

In step S805, the system control unit 50 acquires the RAW data of the new representative image frame from the RAW file, performs a development process thereon, and generates a thumbnail JPEG. The developed thumbnail JPEG is temporarily stored in the memory 32. Here, the development process will be described in detail. In a case where the frame confirmation screen of FIG. 5AD is being displayed on the display unit 28, the display image 5004 is an image of the frame 15 of FIG. 6A. Since an operation instruction for extracting the frame 15 as a single image was performed, the RAW data that is the development target is the RAW data of the frame 15 in FIG. 6A. The system control unit 50 performs a development process on the RAW data of the frame 15 based on the imaging information acquired in step S801 and the frame information of the frame 15 acquired in step S803, generates a thumbnail JPEG, and stores it temporarily in the memory 32.

In step S806, the system control unit 50 performs processing to generate the representative image information. The generated representative image information is temporarily stored in the memory 32. The processing for generating the representative image information will be described here in detail. In a case where the frame confirmation screen of FIG. 5AD is being displayed on the display unit 28, the display image 5004 is an image of the frame 15 of FIG. 6A. Since an operation instruction for extracting the frame 15 as one image was performed, the frame information that is the target of the processing for generating the representative image information is the frame information of the frame 15 of FIG. 6A. Based on the imaging information acquired in step S801 and the frame information of the frame 15 acquired in step S803, the processing for generating the representative image information is performed.

In step S807, the system control unit 50 performs file generation processing. In the file generation process, a file having a file structure as illustrated in FIG. 6B is generated based on the raw data and the information generated in steps S804 to S806, and the file structure is written to the storage medium 200. FIG. 6B illustrates an example of a file generated by selecting and saving the frame 15 of FIG. 6A. When the generated file is written to the storage medium 200, the system control unit 50 completes the file save process 1.

### Series of Operations Pertaining to File Save Process

Next, referring to FIG. 9, a series of operations of the file save process 2 in which the number of images in the range of editing target images is more than one will be described. Similar to the processing of FIG. 8, the file save process 2 is realized by the system control unit 50 loading a program stored in the nonvolatile memory 56 into the memory 32 and executing the program. In addition, in the following explanation, a case of a file configuration as in FIG. 6A, and in which the file save process 2 is executed by designating a frame range from a group-RAW-image file having 60 frames and whose representative image frame is the frame 20 will be described.

In step S901, the system control unit 50 acquires the imaging information and the representative image information in the group-RAW-image, and temporarily stores them in the memory 32. In step S902, the system control unit 50 determines whether or not the frame corresponding to the representative image is included in the frames designated in step S714. The system control unit 50 compares, for example, a frame of a representative image identified based on the acquired representative image information with a range designated as an editing target. Then, in a case where it is determined that the frame corresponding to the representative image is included, the process proceeds to step S904, and otherwise, the process proceeds to step S903.

In step S903, the system control unit 50 determines whether or not the frames of the range designated in step S714 are after the frame corresponding to the representative image. In a case where it is determined that the frames of the designated range are after the frame corresponding to the frame representative image, the system control unit 50 advances to step S906 and otherwise proceeds to step S905.

In step S904, the system control unit 50 determines whether or not the frame corresponding to the representative image is towards the rear in the frames designated in step S714 by more than a threshold. The threshold value may be, for example, a threshold corresponding to the 10% of the frames towards the rear in the frames in the selected range. In a case where it is determined that the frame corresponding to the representative image is towards the rear of the threshold, the system control unit 50 advances to step S906 and otherwise proceeds to step S907 (if it is before the threshold value).

In step S905, the system control unit 50 determines the end frame in the frames designated in step S714 as a new representative image frame. In step S714, in a case where frames 1 to 3 of FIG. 6A are designated as in FIG. 5BB in the multiple frame selection screen, the new representative image frame becomes frame 3.

In step S906, the system control unit 50 determines the head frame in the frames selected in step S714 as a new representative image frame. In step S714, in a case where frames 59 to 60 of FIG. 6A are designated as in FIG. 5BC in the multiple frame selection screen, the new representative image frame becomes frame 59. In step S714, in a case where frames 1 to 20 of FIG. 6A are designated as in FIG. 5BD in the multiple frame selection screen, the new representative image frame becomes frame 1.

In step S907, the system control unit 50 determines the representative image frame of the RAW data images (i.e., the representative image frame prior to editing) as the new representative image frame. That is, the representative image is not changed. In step S714, in a case where frames 19 to 21 of FIG. 6A are designated as in FIG. 5BE in the multiple frame selection screen, the new representative image frame becomes frame 20. That is, the frame corresponding to the representative image before editing is included in the designated range, and even though the frame corresponding to the representative image is not the head of the designated range, the representative image before editing becomes the new representative image frame.

In step S908, the system control unit 50 acquires frame information of the new representative image frame from the group-RAW-image, and temporarily stores it in the memory 32. In the case of FIG. 5BB, the frame information of the frame 3 of FIG. 6A is acquired. In the case of FIG. 5BC, the frame information of the frame 59 of FIG. 6A is acquired. In the case of FIG. 5BD, the frame information of the frame 1 of FIG. 6A is acquired. In the case of FIG. 5BE, the frame information of the frame 21 of FIG. 6A is acquired.

In step S909, the system control unit 50 generates a display JPEG by acquiring, from the RAW file, RAW data of a new representative image frame, and performing a development process thereon, and stores the generated display JPEG (size: small) temporarily in the memory 32. Here, the development process will be described in detail. The RAW data that is the development target is the RAW data of the frame corresponding to the new representative image. The system control unit 50 performs a development process based on the imaging information acquired in step S901 and the frame information acquired in step S908. In this development process, a development process is performed at the same size (resolution) as the display JPEG of the frame corresponding to the new representative image to generate a display JPEG image (size: small) and temporarily store it in the memory 32. The process then proceeds to step S910.

In step S910, the system control unit 50 generates a thumbnail JPEG by acquiring, from the RAW file, RAW data of the new representative image frame, and performing a development process thereon, and stores the generated thumbnail JPEG temporarily in the memory 32. Here, the development process will be described in detail. The RAW data that is the development target is RAW data of a frame corresponding to the new representative image. A development process is performed based on the imaging information acquired in step S901 and the frame information acquired in step S908. In this development process, a thumbnail JPEG is generated and temporarily stored in the memory 32.

In step S911, the system control unit 50 acquires the frame information of the new representative image frame from the RAW file, and performs processing to generate the representative image information. The generated representative image information is temporarily stored in the memory 32. The processing for generating the representative image information will be described here in detail. The frame information that is the target of the processing for generating the representative image information is the frame information of the frame corresponding to the new representative image determined by either steps S905 to 907. The system control unit 50 performs a process for generating the representative image information based on the imaging information acquired in step S901 and the frame information acquired in step S908.

In step S912, the system control unit 50 performs file generation processing. In the file generation process, the group-RAW-image file is generated based on the information generated in steps S909 to S911, and written to the storage medium 200. FIG. 6C is a file generated by designating and saving frames 1 to 3 of FIG. 6A. FIG. 6D is a file generated by designating and saving frames 59 to 60 of FIG. 6A. FIG. 6E is a file generated by designating and saving frames 1 to 20 of FIG. 6A. FIG. 6F is a file generated by designating and saving frames 19 to 21 of FIG. 6A. Note that in step S907, in a case where representative image frame before editing is set as the new representative image frame, the representative image frame is not changed. Therefore, in steps S908 to S911, the frame information of the representative image frame, the display JPEG, the thumbnail JPEG, and the representative image information may be acquired from the moov and uuid of the group-RAW-image file without performing the development process, the generation processing, or the like, and used unchanged. After completing the process of generating the file, the system control unit 50 terminates the file save process 2.

In the description of above step S904, in a case where the frame corresponding to the representative image is towards the rear of the threshold (e.g., 10%) among the frames of the designated range designated in step S714 as the editing target, the representative image prior to editing is used as the representative image (i.e., the representative image is not changed). However, in a case where the frame corresponding to the representative image is included in the frames of the designated range that is designated in step S714 as the editing target, the representative image prior to editing may be used as the representative image (the representative image is not changed) regardless of the position of the frame corresponding to the representative image within the designated range. By doing this, it is possible to provide an appropriate representative image while reducing the processing in the case where the representative image frame is within the designated range that is the editing target.

Hereinafter, effects according to the present embodiment described above will be summarized.

In the group-RAW-image illustrated in FIG. 6A, the frame at the time of pressing the SW 2 at the time of imaging corresponds to the representative image as described above. For this reason, in a case where an editing process and saving are performed where a plurality of frames are designated, there are cases where, when the representative image is not updated in accordance with the designated range, the representative image cannot be appropriately updated with respect to the edited group-RAW-image. For example, there are cases where an undesired frame becomes the representative image such as when there is an update in a case where the group-RAW-image does not need to be updated, or when an image not included in the edited group-RAW-image becomes the representative image. In the present embodiment, by performing processing to determine the new representative image as in steps S905 to S907 in the file save process, a representative image suitable for the edited group-RAW-image can be stored. In a case where it is determined in step S904 that the representative image frame is towards the rear of the designated range, even if the image corresponding to the representative image before editing is included in the designated range after editing, it is determined that the appropriate representative image is in the first half of the group-RAW-image, and the representative image is updated. This makes it possible to change the representative image stored in the group-RAW-image to an appropriate representative image.

Further, the group-RAW-image illustrated in FIG. 6A does not include a high-quality JPEG as an image for displaying because it is necessary to abridge processing such as image compression at the time of imaging as described above. Therefore, in a case where the file is saved without performing a development process when one frame is selected, the result is only the display image and the raw data as with the data of the frame 21 illustrated in the mdat of FIG. 6B. With this alone, when RAW development by a separate process is not performed, a high-quality display image is not generated as the extracted RAW data, and for example, the number of operations will increase in an operation of enlarging the display image and confirming whether or not it is focussed.

On the other hand, in the embodiment described above, the development process is performed from the RAW data corresponding to a frame to be extracted as in step S705 in the course of the extraction processing. On the other hand, although simultaneous performance of development and the file saving in step S705 can be considered, if the file saving is executed, there is the possibility that an image that will not be in focus when it is later enlarged will be erroneously extracted, and there is a possibility that a redo will be necessary. Therefore, the timing of the development process and the file save process are separated as in the case of steps S705 and S711, and also the image is enlarged and played back during the course of the development process and the file save process so that image details can be confirmed. When the file is saved, the image is replaced with a high-quality image generated in the preceding development process. That is, the image generated by the development process and stored in the memory and the display image after the file saving end up being the same.

By doing so, the user can confirm the image quality before saving the file, and the possibility of extracting an unintended frame can be reduced. It is also possible to reduce wasteful processing time.

As described above, in the present embodiment, it is possible to improve operability at the time of extracting a plurality of images imaged consecutively before and after an imaging instruction by each of the above-described processes: the group playback process, the file save process 1, and the file save process 2. More specifically, when frame selection (step S702) is performed, operations can be performed smoothly, and image quality can be confirmed by enlarging (step S709) the file prior to saving the file. That is, the possibility that the user will extract an unintended frame is reduced, and the time that the entire operation, including selecting and extracting images and image checking, takes can be shortened (because there is no duplicate processing in steps S704 and S711 processing).

When there are a plurality of images in the range of images that is the editing target, the representative image is updated in view of the relationship between the range designated as the editing target and the frame corresponding to the representative image (steps S905 to 907 of the file save process 2). This makes it possible to change the group-RAW-image after editing to an appropriate representative image, as described above in the summary of effects. In other words, in a case where an image or a consecutive range is extracted from a plurality of consecutively imaged images before and after the imaging instruction, a corresponding representative image can be made to be an appropriate representative image.

The file save process of step S711 has been described by exemplifying a case where the save as RAW 512 is selected in step S710. On the other hand, the file save process in a case of selection to save as JPEG is simpler than the file save process in a case where of selection to save as RAW. Specifically, the display JPEG temporarily stored in the memory 32 may be copied. The file structure generated in this case is illustrated in FIG. 6E. In this case, the file save process has an advantage that the processing time can be reduced as compared with the prior art.

In addition, an example is illustrated in which, in a case where a plurality of frames are designated by step S714, development corresponding to RAW images is not performed. This is because the main use case for extraction of a group-RAW-image with a plurality of frames is the deletion of unnecessary frames, and it is thought that the first half and the second half of the 60 frames present will often include unintended frames. Since the group-RAW-image described above includes RAW data for all frames, there is a high possibility that the size of the file will be large, and so there will be a need to economize on storage capacity. Therefore, since there are few use cases for the purpose of designating a plurality of images (extracting a plurality of images) to confirm the focus of the images one by one, a development process (a development process for generating a high-quality image) of a RAW image is not performed. On the other hand, in a case where generation of high-quality JPEG images one by one is desired even with the extraction process on a selection of a plurality of images, whether or not to perform the development process may be switched depending on the number of images designated. That is, configuration may be such that in a case where more than a predetermined number of images are designated as the editing target, the development process is not be performed, and when the predetermined number of images or less are designated as the editing target, the development process is performed for each of RAW images.

Further, in the present embodiment, processing for extracting from a group-RAW-image has been described as an example, but similar processing may be applied to a RAW file of a moving image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-184986, filed Sep. 28, 2018, which is hereby incorporated by reference herein in its entirety.

What is claimed is:

1. An editing apparatus comprising at least one memory and at least one processor which function as:
an acquiring unit configured to acquire a plurality of consecutive images imaged before and after an imaging instruction, an image imaged at a timing of the imaging instruction corresponding to a representative image;
a designation unit configured to designate one or more images to be an editing target, out of the plurality of images; and
a control unit configured to control such that, in a case where the image corresponding to the representative image is included in editing target images designated by the designation unit, the representative image is not changed in an editing process, and to control such that, in a case where the image corresponding to the representative image is not included in editing target images designated by the designation unit, the representative image is changed in the editing process to an image corresponding to an image included in the editing target images designated by the designation unit.

2. The editing apparatus according to claim 1, wherein, in a case where the number of editing target images designated by the designation unit is less than a predetermined number, the control unit updates the representative image in the editing process regardless of whether or not editing target images designated by the designation unit include the image corresponding to the representative image.

3. The editing apparatus according to claim 1, wherein, in a case where one image is designated as the editing target by the designation unit, the control unit updates, in the editing process, the representative image regardless of whether or not the editing target image designated by the designation unit is the image corresponding to the representative image.

4. The editing apparatus according to claim 1, wherein the designation unit can designate a range of editing target images from among the plurality of images.

5. The editing apparatus according to claim 1, wherein, in a case where the image corresponding to the representative image is included in editing target images designated by the designation unit, the control unit does not update the representative image in the editing process regardless of the position of the image corresponding to the representative image in the editing target images designated by the designation unit.

6. The editing apparatus according to claim 1, wherein, in a case where the image corresponding to the representative image is included in editing target images designated by the designation unit, the control unit
does update, in the editing process, the representative image to an image corresponding to an image of a position at or before the predetermined threshold in the editing target images designated by the designation unit when the position of the image corresponding to the representative image is a position more towards the rear than a predetermined threshold in the editing target images designated by the designation unit, and
does not update, in the editing process, the representative image when the position of the image corresponding to the representative image is a position at or before the predetermined threshold in the editing target images designated by the designation unit.

7. The editing apparatus according to claim 6, wherein the control unit updates the representative image to an image corresponding to an image at a head position of the editing target images designated by the designation unit when updating the representative image to an image corresponding to an image at the position at or before the predetermined threshold in the editing target images designated by the designation unit.

8. The editing apparatus according to claim 1, wherein, in a case where the image corresponding to the representative image is not included in the editing target images designated by the designation unit, the control unit updates, in the editing process, the representative image to an image corresponding to an image of a position closest to a position of the image corresponding to the representative image in the editing target images designated by the designation unit.

9. The editing apparatus according to claim 8, wherein the control unit updates, in the editing process, the representative image to an image corresponding to an end image in the editing target images designated by the designation unit when the position of the image corresponding to the representative image is a position more toward the rear than the predetermined threshold in the editing target images designated by the designation unit, and updates, in the editing process, the representative image to an image corresponding to the head image of the editing target images designated by the designation unit when the position of the image corresponding to the representative image is a position before the predetermined threshold in the editing target images designated by the designation unit.

10. The editing apparatus according to claim 1, wherein a plurality of consecutive images imaged before and after the imaging instruction are included in one file together with representative image information in which the position of the representative image among the plurality of images is recorded, and
in a case where the representative image is updated, the control unit updates the representative image information based on the position of the image corresponding to the updated representative image.

11. The editing apparatus according to claim 1, wherein each of the plurality of consecutive images imaged before and after the imaging instruction is a RAW image.

12. The editing apparatus according to claim 1, wherein, in a case where only one image is designated by the designation unit as an editing target image, the control unit controls to display, on a display, an image obtained by developing a RAW image which is the one image.

13. A method of controlling an editing apparatus, the method comprising:
acquiring a plurality of consecutive images imaged before and after an imaging instruction, an image imaged at a timing of the imaging instruction corresponding to a representative image;
designating one or more images to be an editing target, out of the plurality of images; and
controlling such that, in a case where the image corresponding to the representative image is included in the designated editing target images, the representative image is not changed in an editing process, and controlling such that, in a case where the image corresponding to the representative image is not included in the designated editing target images, the representative image is changed in the editing process to an image corresponding to an image included in the designated editing target images.

14. A non-transitory computer-readable storage medium storing a program for causing a computer to execute a method of controlling an editing apparatus, the method comprising:
acquiring a plurality of consecutive images imaged before and after an imaging instruction, an image imaged at a timing of the imaging instruction corresponding to a representative image;
designating one or more images to be an editing target, out of the plurality of images; and
controlling such that, in a case where the image corresponding to the representative image is included in the designated editing target images, the representative image is not changed in an editing process, and controlling such that, in a case where the image corresponding to the representative image is not included in the designated editing target images, the representative image is changed in the editing process to an image corresponding to an image included in the designated editing target images.
